(19) United States
(12) Patent Application Publication
(10) Pub. No.: US 2006/0104477 A1
(43) Pub. Date: May 18, 2006

(54) Digital watermark detection apparatus and digital watermark detection method

(75) Inventors: Taichi Isogai, Tokyo (JP); Hirofumi Muratani, Kawasaki-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Kabushiki Kaisha Toshiba

(21) Appl. No.: 11/231,513

(22) Filed: Sep. 20, 2005

(30) Foreign Application Priority Data
Nov. 12, 2004 (JP) 2004-329358

(51) Int. Cl. G06K 9/00

(52) U.S. Cl. 382/100

(57) ABSTRACT

A digital watermark detecting apparatus includes an acquisition unit configured to acquire a plurality of base values for computation of a watermark value, which are contained, respectively, in all or some of a plurality of divided regions obtained by dividing digital contents, a computation unit configured to compute variance of the base values, and a determination unit configured to determine whether the digital watermark is contained in the digital contents, based on comparison of the computed variance with a threshold.

### CROSS-REFERENCE TO RELATED APPLICATIONS

This application is based upon and claims the benefit of priority from prior Japanese Patent Application No. 2004-329358, filed Nov. 12, 2004, the entire contents of which are incorporated herein by reference.

### BACKGROUND OF THE INVENTION

1. Field of the Invention

The present invention relates to a digital watermark detection apparatus to detect a digital watermark using topological invariant from digital contents, and a digital watermark detection method.

2. Description of the Related Art

Digital watermarking is a technique of making it difficult to perceive contents (digital contents) such as digitized still image data, motion image data, audio data, and music data by embedding watermark information therein. The watermark information can include information such as identification information of a copyright holder and a user of contents, right information of the copyright holder, a utilization condition of contents, secret information needed when using it, and copy control information. This watermark information is used for performing copyright protection including utilization control and copy control by being detected from the contents if necessary later, or promoting the second utilization.

When contents including such watermark information (indicating a watermark value and making it difficult to perceive the contents) circulate once, the description of the contents may be altered by intentional attack of a user (any cause without user intension) such as deleting or tampering with the watermark information. Accordingly, the technique capable of preventing deletion or alteration of the watermark information contained in the contents even if the description of the contents is tampered becomes important.

There is a digital watermark system (the Topological-Invariant watermark system) to use unchangeable topological invariant under local geometric distortion as the watermark with robust against local distortion such as StirMark attack accompanied by displacement of a pixel or DAD-conversion for returning digital information to analog one once and then digitizing it again (refer to Japanese Patent No. 3431593). According to this phase digital watermark, on a contents generator side, the contents containing the watermark information are generated by changing the part of description of digital contents, in which the watermark information is to be contained, according to the topological invariant corresponding to the watermark information to be contained in the digital contents. On the digital watermark detection apparatus side, the topological invariant contained in the contents is detected based on the part of description of digital contents, in which the watermark information is to be contained, to output the watermark information corresponding to the topological invariant.

Even if the watermark information is not included in the contents in a digital watermark detection operation, a watermark value corresponding to the watermark information may be detected at haphazard from the part of description of contents, in which the watermark information is to be contained. Accordingly, when the contents containing the watermark and the contents containing no watermark are combined, notwithstanding the contents including no watermark, the contents may be determined to include the watermark (refer this false determination to as false positive).

However, in the previous Topological-Invariant watermarking system a method for determining whether the detected watermark value (topological invariant) is one provided based on the watermark information contained in the contents or one provided at haphazard notwithstanding the contents including no watermark is not known.

Further, for example, in digital watermark systems using spectrum spread a deciding method that is lowering False positive rate using a correlation value is known. However, this method is one specialized to a digital watermark system using spectrum spread. It is difficult to apply this method to the Topological-Invariant watermark system.

It is an object of the present invention to provide a digital watermark detection apparatus and method capable of lowering event probability of false positive in a digital watermark system using phase invariant.

### BRIEF SUMMARY OF THE INVENTION

An aspect of the present invention provides A digital watermark detecting apparatus to detect a digital watermark contained in digital contents, comprising: a contents divider to divide digital contents into a plurality of divided regions; an acquisition unit configured to acquire a plurality of base values for computation of a digital watermark value, which are contained in all or some of the plurality of divided regions, respectively; a computation unit configured to compute variance of the base values; and a watermark determination unit configured to determine whether the digital watermark value is contained in the digital contents, based on comparison of the computed variance with a threshold.

### BRIEF DESCRIPTION OF THE SEVERAL VIEWS OF THE DRAWING

FIG. 1 is a diagram for explaining a system to which a digital watermark detection apparatus concerning one embodiment of the present invention is applied.

FIG. 2 is a diagram for explaining the Topological-Invariant watermark method.

FIG. 3 is a diagram for describing to divide an object contents image into a plurality of small region blocks.

FIG. 4 is a diagram for explaining a case wherein a digital watermark is contained in object contents.

FIG. 5 is a diagram for explaining a case wherein no digital watermark is contained in object contents.

FIG. 6 is a diagram showing a configuration of the digital watermark detection apparatus concerning the embodiment.

FIG. 7 is flowchart illustrating a processing procedure of the digital watermark detection apparatus of FIG. 6.

FIG. 8 is flowchart illustrating another processing procedure of the digital watermark detection apparatus of FIG. 6.

FIG. 9 is a diagram showing another configuration of the digital watermark detection apparatus concerning the embodiment.

FIG. 10 is flowchart illustrating a processing procedure of the digital watermark detection apparatus of FIG. 9.

FIG. 11 is flowchart illustrating another processing procedure of the digital watermark detection apparatus of FIG. 9.

FIG. 12 is a diagram for explaining the threshold.

### DETAILED DESCRIPTION OF THE INVENTION

There will be described an embodiment of the present invention in conjunction with appended drawings.

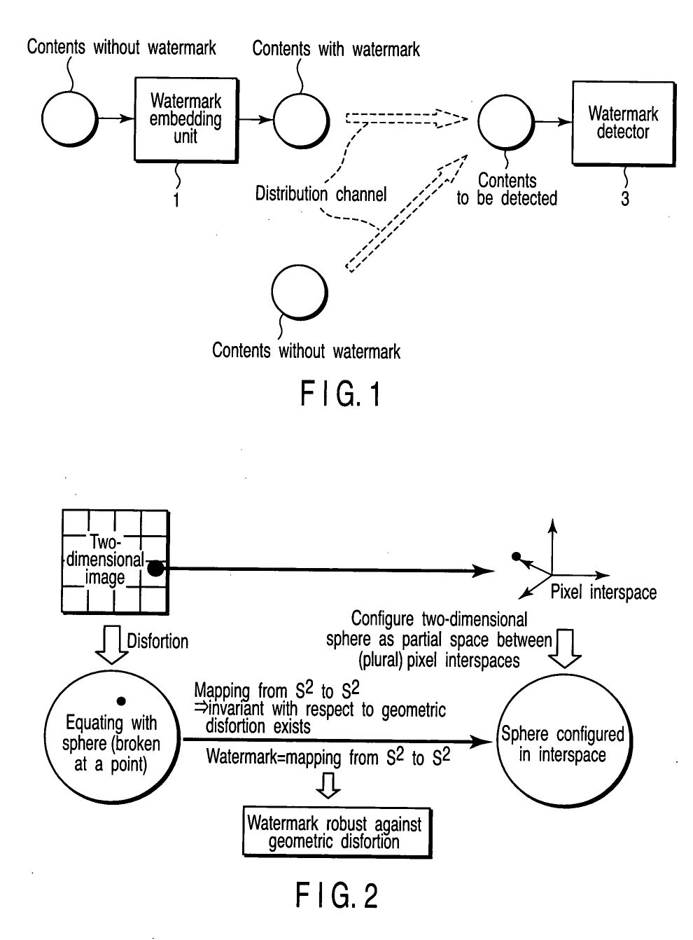

FIG. 1 shows a conceptual diagram of a system wherein a digital watermark detection apparatus concerning the embodiment of the present invention is applied.

A digital watermark embedding unit (contents generator) 1 is supplied with object digital contents to be processed and watermark information to be embedded therein (topological invariant corresponding to the watermark information). The digital watermark embedding unit changes the part of description of contents, in which the watermark information is to be contained, according to topological invariant corresponding to the watermark information to be contained in the contents, and generate the contents containing the watermark information. The digital watermark embedding unit 1 is mounted on a system of the contents provider side and managed thereby.

It is referred as to digital watermark embedding to change, in the Topological-Invariant watermarking, the part of description of object contents, in which a digital watermark is to be contained, according to topological invariant corresponding to watermark information to be contained in object contents.

The contents containing the watermark information (referred to as watermarked contents) and contents containing no watermark information (referred to as non-watermarked contents) are circulated via distribution channels 2 with medium such as memory medium or communication medium. On that occasion, in the distribution channel 2, local distortion such as StirMark attack or DAD-conversion may be done to the contents. The local distortion may be done by intention of a user, or without intention or recognition of a user.

The digital watermark detector 3 is supplied with object digital contents to be detected. At first the digital watermark detector 3 determines whether the contents are watermarked contents or non-watermarked contents. In this case, the digital watermark detector 3 determines whether or not watermark information is contained in the contents based on the part of description of object digital contents, in which the watermark information is to be contained. When the digital watermark detector 3 determines that the object contents contain watermark information, that is, they are watermarked contents, it detects topological invariant contained in the object contents based on the part of description of contents, in which the watermark information is to be contained, to output watermark information corresponding to the topological invariant. In this time, indication containing the watermark information or indication of watermarked contents may be output explicitly along with the watermark information.

On the other hand, when the digital watermark detector 3 determines that the contents contain no watermark information, that is, they are non-watermarked contents, it outputs indication containing no watermark information or indication of non-watermarked contents. The digital watermark detector 3 may be built in a contents utilization apparatus of the user side for the purpose of copyright guard at the time of the contents utilization, or may be mounted on a contents provider for the purpose of detecting the watermark information from the contents via the circulation.

If it is proved from some information that the object contents are the watermarked contents or the non-watermarked contents, the digital watermark detector 3 can be configured to omit a determination process.

The digital watermark embedding unit 1 can use one described by Japanese Patent No. 3431593 or one corresponding to this. The part of the digital watermark detector 3 of the present embodiment that detects from the watermarked contents the topological invariant contained in the contents and outputs watermark information corresponding to this topological invariant can use one described by Japanese Patent No. 3431593 or one corresponding to this. In addition, in the case that the object contents are watermarked contents generated with the digital watermark embedding unit 1, even if StirMark attack or DAD-conversion is done against the contents in the distribution channel 2, the digital watermark detector 3 can detect the watermark information correctly.

The part of the digital watermark detector 3 that determines whether or not watermark information is contained in the contents will be described in detail hereinafter.

The present embodiment is described with the assumption that the watermarked contents circulates as digital contents, and the digital contents are input to the digital watermark detector 3. However, in the case that, for example, the watermarked contents are circulated as digital contents, converted into analog contents in the circulation channel, and input to the digital watermark detector 3, a function that is converting analog contents input into digital contents may be loaded on the digital watermark detector 3.

The digital watermark embedding unit 1 can be realized as software (program) and hardware. Similarly, the digital watermark detector 3 can be realized as software (program) and hardware. When the digital watermark embedding unit 1 and digital watermark detector 3 are used on the contents provider side, they may be integrated. When the digital watermark detector 3 is built in the contents utilization apparatus on the user side, it is desirable that users are prohibited from operating, analyzing, and attacked.

The following configuration diagram can be used as a functional block diagram of an apparatus and as a functional module diagram of software (program) or a procedure diagram.

In the present embodiment, there is described a case that the digital contents are mainly (still) image data. Of course, the digital contents may be data of other media. The local distortion such as StirMark attack or DAD-conversion is geometry distortion of still image data in the case of, for example, still image, and deformation of a time base direction of audio data in the case of speech. As for the video, when it is processed in units of a frame, the local distortion is geometry distortion similar to the still image. When the video is processed in consideration of temporal positions over a plurality of frames, the local distortion is geometric distortion and distortion of a time base direction (spatio-temporal distortion).

There is described the Topological-Invariant watermark system as a concrete example of the present embodiment. This system is explained in detail with homotopy invariant as an example of topological invariant by Japanese Patent No. 3431593.

The Topological-Invariant watermark system used in a concrete example of the present embodiment is configured to have robust against local distortion such as StirMark attack or DAD-conversion by containing topological invariant corresponding to watermark information in the digital contents (by changing the part of description of object contents so that topological invariant derived from the object contents becomes a value corresponding to the watermark information to be contained in the part of description, concretely, by controlling the pixel value of a specific pixel of the object image contents).

In the Topological-Invariant watermark system, the digital watermark is associated with the topological invariant in considering local geometric distortion to be a homeomorphism. For the purpose of realizing the robust against this local geometric distortion, the topological invariant (for example, homotopy class) unchangeable under the local geometric distortion is embedded in the contents as a digital watermark in the Topological-Invariant watermark system. This concept is shown in FIG. 2 as an example that the object contents are an image.

An integer value (value taking into account of a surrounding direction) indicating whether one orbit along the equator in the base space corresponds to how many orbits along the equator in the object space is the phase invariant. Assuming that the upper left of the two-dimensional plane (base space) of FIG. 2 is a north pole. In the case of homotopy class n=1, the circumference (end) of the image corresponds to a part of a north pole of the two-dimensional sphere (object space) of FIG. 2, and the center of the image corresponds to a part of a south pole of the two-dimensional sphere of FIG. 2. The parts between the north and south pole parts correspond to each other continuously. In other words, one orbit along the equator in the base space corresponds to one orbit along the equator in the object space. In the case of homotopy class n=−1, one orbit along the equator in the object space is a reverse turn in comparison with the case of n=1. In the case of n=2 or −2, one orbit along the equator in the base space corresponds to two orbits along the equator in the object space.

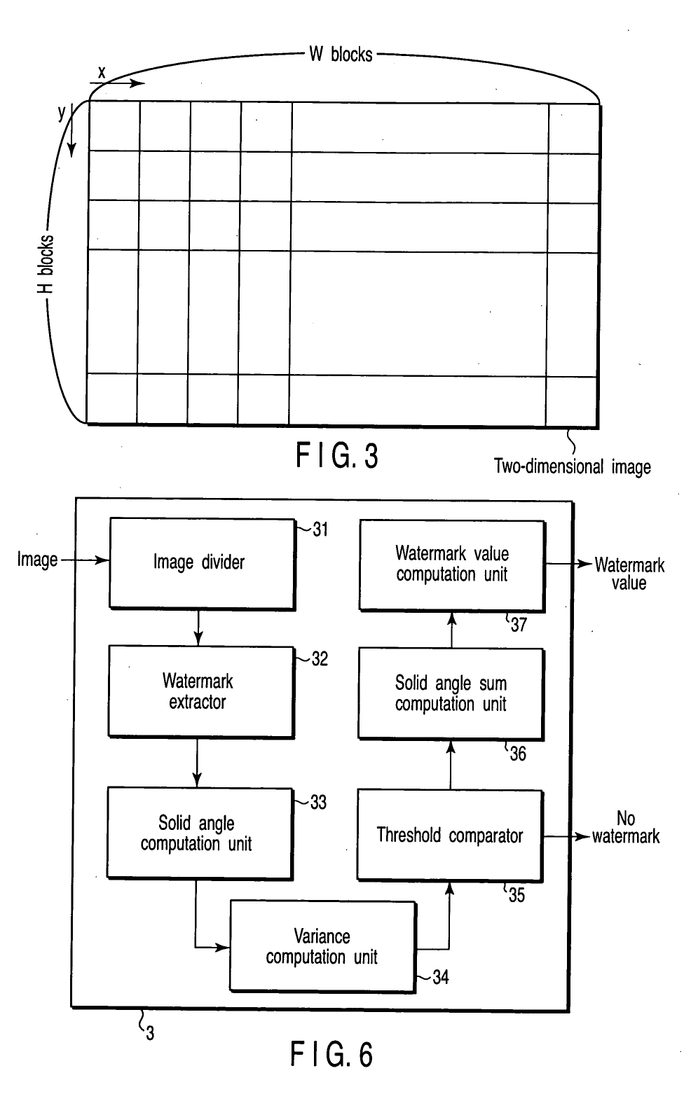

Assume that the object contents are image contents, and the homotopy class is used as topological invariant. Concretely, assume that the width of the image is W, and the height of the image is H. The object contents image is divided into small region blocks of H in height×W in width as shown in FIG. 3 (each small block has one pixel or a plurality of pixels), and the pixel of upper left of the image is (x, y)=(0, 0), and a watermark value (value of topological invariant) corresponding to the watermark information is assumed to be n, and the following equations (1) to (3) are assumed to be established.

$$\begin{matrix}θ = 2 arctan [ 2 / \vert tan 2 \{ ( π / 2 ) ( x / W - 1 / 2 ) \} + tan 2 \{ ( π / 2 ) \times ( y / H - 1 / 2 ) \} \vert ] & ( 1 ) \\ cos ϕ = tan 2 \{ ( π / 2 ) \times ( x / W - 1 / 2 ) \} / \vert tan 2 \{ ( π / 2 ) \times ( x / W - 1 / 2 ) \} + tan 2 \{ ( π / 2 ) \times ( y / H - 1 / 2 ) \} \vert & ( 2 ) \\ sin ϕ = tan 2 \{ ( π / 2 ) \times ( y / H - 1 / 2 ) \} / \vert tan 2 \{ ( π / 2 ) \times ( x / W - 1 / 2 ) \} + tan 2 \{ ( π / 2 ) \times ( y / H - 1 / 2 ) \} \vert & ( 3 )\end{matrix}$$

Then, the following function belonging to the homotopy class as expressed by equation (4) is obtained.
(X, Y, Z)=(sin θ cos nφ, sin θ sin nφ, cos θ) (4)

The digital watermark embedding unit embeds this function in an object image. In other words, the value of a given pixel of the small region block is changed so that the vector ff(x, y)=(Xxy, Yxy, Zxy) given as a value of the function and becoming a watermark component for the small region block is contained in each small region block of FIG. 3 in the object image. On that occasion, there i-s a method of using only a region of a part of the image (for example, central part of the image) other than a method of using all regions of the image. Alternatively, there is a method of using only bits of a part of the pixel value (a region of, for example, specific middle bit plane) other than a method of using all bits of a pixel value. These methods are disclosed in detail in Japanese Patent No. 3431593.

In contrast, on the digital watermark detector side, at first an object image is divided into a plurality of small region blocks like the digital watermark embedding (in an example of FIG. 3, the image is divide into small region blocks of H in height×W in width). The vector ff(x, y)=(Xxy, Yxy, Zxy) becoming a watermark component is extracted from each small region block.

A solid angle is computed from each small region block by the following equation. The solid angle of each small region block is computed by the following equation (5).
ff(x, y)·(Δx ff(x, y)×Δy ff(x, y)) (5)
where
x represents an inner product, and ·an outer product.
   when x≠W−1: Δxff(x, y)=ff(x+1, y)−ff(x, y)(f6 −1)
   when x=W−1: Δxff(x, y)=ff(0, y)−ff(W−1, y)(6 −2)
   when y≠H−1: Δyff(x, y)=ff(x, y+1)−ff(x, y)(7 −1)
   when y=H−1: Δyff(x, y)=ff(x, 0)−ff(x, H−1)(7 −2)

The summation of the above solid angles, that is, Σ_{H}Σ_{W}ff(x, y)·(Δxff(x, y)×Δyff (x, y)) is computed. The number of orbits of a unit sphere that corresponds to this summation is computed by (¼π) Σ_{H}Σ_{W}ff(x, y)·(Δxff(x, y)×Δyff(x, y)). The value of the computed result is rounded off and digitized in an integer value to obtain a watermark value (value of topological invariant). This watermark value is converted into digital watermark information.

There will be described the part of the watermark detector 3 of the present embodiment that determines whether or not the watermark information is contained in the contents in detail. It is assumed that object digital contents are image data. The fundamental concept of this decision technique will be described.

In the Topological-Invariant watermark system using topological invariant, mapping is done from the base space defined by a space and/or temporal position in the object digital contents to an object space according to a function for making the topological invariant contain in the contents. The watermark value (i.e., topological invariant) can be derived from a watermark component on the object space.

Mapping is done from a two-dimensional plane (two-dimensional plane of an object image) to a two-dimensional sphere (two-dimensional sphere that, for example, the function value is given) as described above (refer to FIG. 2). The watermark value (i.e., topological invariant) is obtained by computing a solid angle on the two-dimensional sphere.

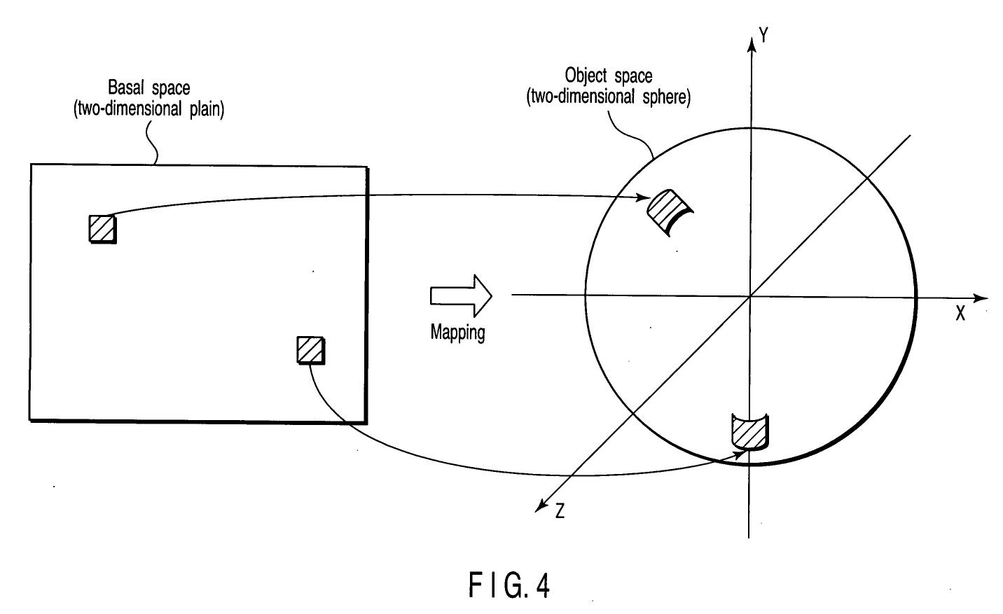

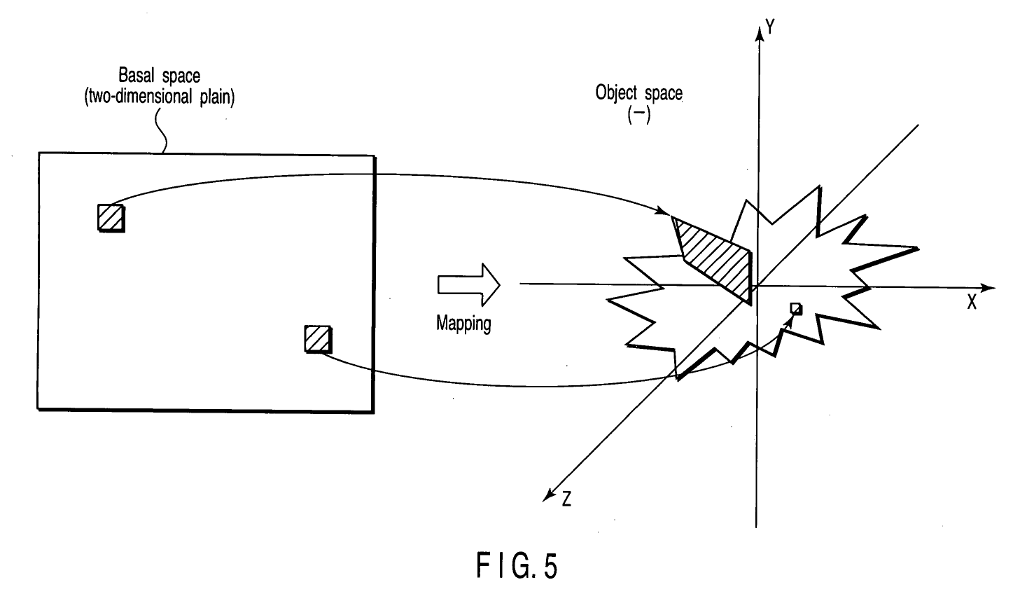

In the case that the object contents are watermarked contents, when the contents image is divided into a plurality of small region blocks, a watermark component is extracted from each small region block, and a solid angle is computed. The solid angles computed from the small region blocks, respectively, have very near value to each other (refer to FIG. 4). In contrast, in the case that the object contents are non-watermarked, even if the same process is done, the solid angles computed from the small region blocks, respectively, have various values (refer to FIG. 5).

In the present embodiment, this difference between the watermarked contents and the non-watermarked contents is used for determination of false positive.

Concretely, the solid angles are computed with respect to all or some of the small region blocks forming the object contents. Subsequently, variance of the solid angles is computed. If the variance is not more than a threshold, it is determined that the object contents contain the digital watermark. If this variance exceeds the threshold, it is determined that the digital watermark is not included in the object contents.

A configuration example of the digital watermark detector 3 related to the present embodiment is described hereinafter.

FIG. 6 shows a configuration example of the digital watermark detector 3 related to the present embodiment. As shown in FIG. 6, this digital watermark detector 3 comprises an image divider 31, a watermark extractor 32, a solid angle computation unit 33, a variance computation unit 34, a threshold comparator 35, and a solid angle sum computation unit 36. The digital watermark detector 3 determines whether a digital watermark is included in the object contents and detects the digital watermark when the digital watermark is included in the object contents.

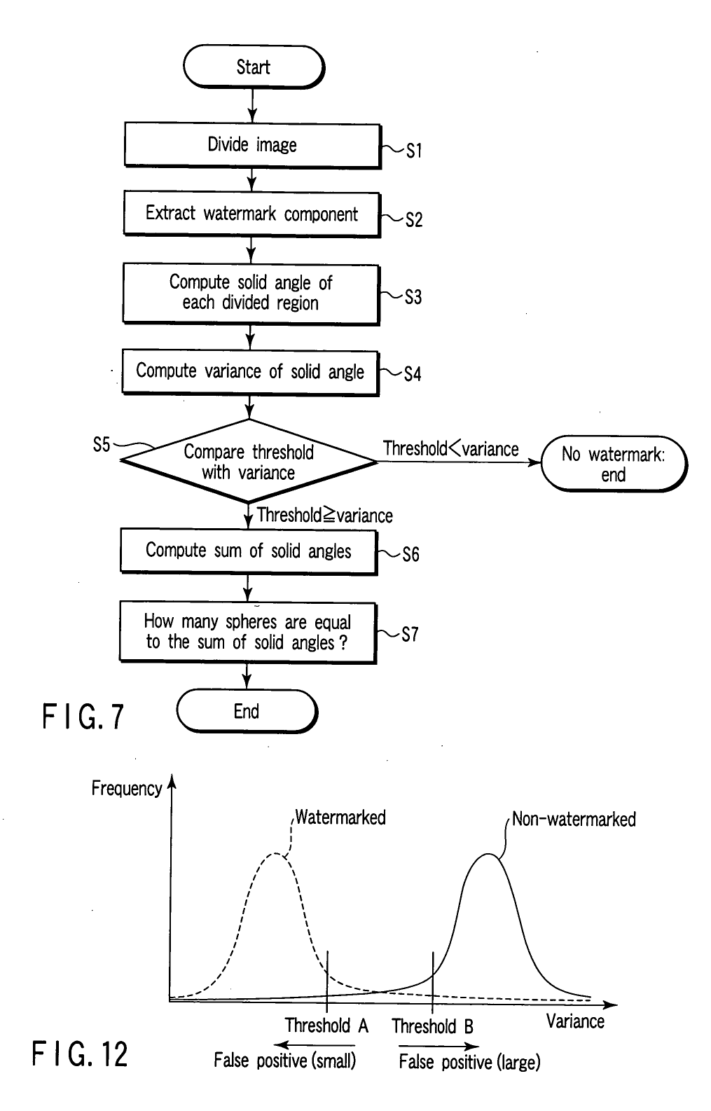

FIG. 7 shows an example of a processing producer of the digital watermark detector 3. The image divider 31 divides an image of object digital contents into a plurality of small region blocks (step S1). The watermark extractor 32 extracts a watermark component from each of all or some of small region blocks (step S2). The solid angle computation unit 33 computes a solid angle based on the extracted watermark component for each block (step S3).

The variance computation unit 34 computes variance of the solid angles obtained from the object small region blocks, respectively (step S4). The threshold comparator 35 compares the obtained variance with a certain threshold for a decision reference. If the variance is not more than the threshold, the threshold comparator 35 determines that a digital watermark is included in the object contents. If the variance exceeds a certain threshold, it determines that a digital watermark is not included in the object contents (step S5).

When it is determined that a digital watermark is not included in the contents, information indicating this is output without doing processes of a solid angle sum computation unit 36 and a watermark value computation unit 37. When it is determined that a digital watermark is included, the solid angle sum computation unit 36 computes a sum of the solid angles of all small region blocks derived from the object image (step S6). When only one part of all small region blocks derived from the object image in steps S2, S3 is intended (when the entire image is not intended), the watermark components are extracted from the remaining small region blocks that are not intended with the watermark extractor 32, respectively, before step S6, and then the solid angle is computed by the solid angle computation unit 33.

Even if some of all small region blocks derived from the object image are used, that is, the entire area of the image is not intended, for computation of variance, the watermark components on all small region blocks may be extracted with the watermark extractor 32, and the solid angles on the necessary small region blocks may be computed with the solid angle computation unit 33 only when needed. Alternatively, the solid angles on all small region blocks may have been computed with the watermark extractor 32 and solid angle computation unit 33.

The watermark value computation unit 37 outputs an integer value obtained by rounding off the sum of the computed solid angles as a watermark value (i.e., topological invariant) (step S7).

According to this configuration example, the digital watermark system using the topological invariant decreases the provability that it misdetermines that a digital watermark is included in the contents though the digital watermark is not contained therein, resulting in outputting a watermark value produced accidentally.

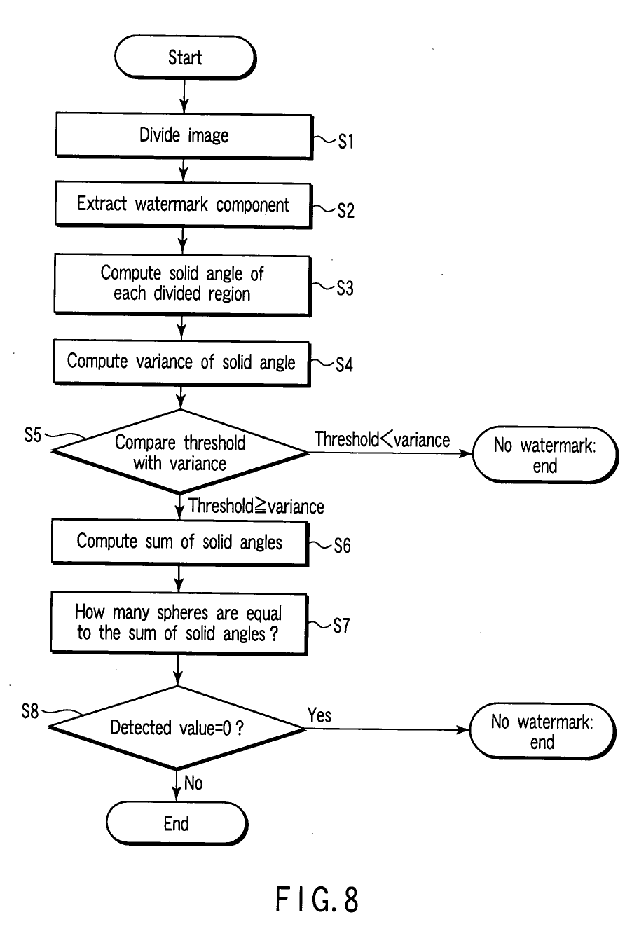

In a natural image containing no digital watermark, most matters tend to have large variance. However, in an artificial image, even if a digital watermark is not included in the image, the variance of the solid angles may become very small. However, the artificial image that the variant of the solid angles becomes very small has a characteristic that 0 is detected as a watermark value. When such contents may become object contents, the system can deal with the contents by a method of not embedding “0” in the contents as a watermark value (value of topological variant). In the case that this method is employed, when 0 is detected as a watermark value, the contents may be considered to contain no digital watermark in the watermark value computation unit 37 of the digital watermark detector. FIG. 8 shows a flow adding such a process (step S8) to the procedure of FIG. 7. A ratio of false detection is further decreased when the above contents may become object contents.

In the examples of FIGS. 7 and 8, the solid angle sum computation unit 36 computes solid angles in a process of computing variance of the solid angles. Therefore, when all small region blocks derived from the object image are used for computation of variance (when the whole area of the image is intended), the computed solid angle sum may be stored. In this case, the solid angle sum computation unit 36 and step S6 may be omitted from the examples of FIGS. 6 and 7 or the example of FIG. 8.

In the FIGS. 7 and 8 examples, the watermark value (i.e., value of topological invariant) derived from the object contents is output as it is. However, the watermark value may be converted into watermark information and this watermark information (or watermark value and watermark information) may be output. The threshold may be set by a user appropriately.

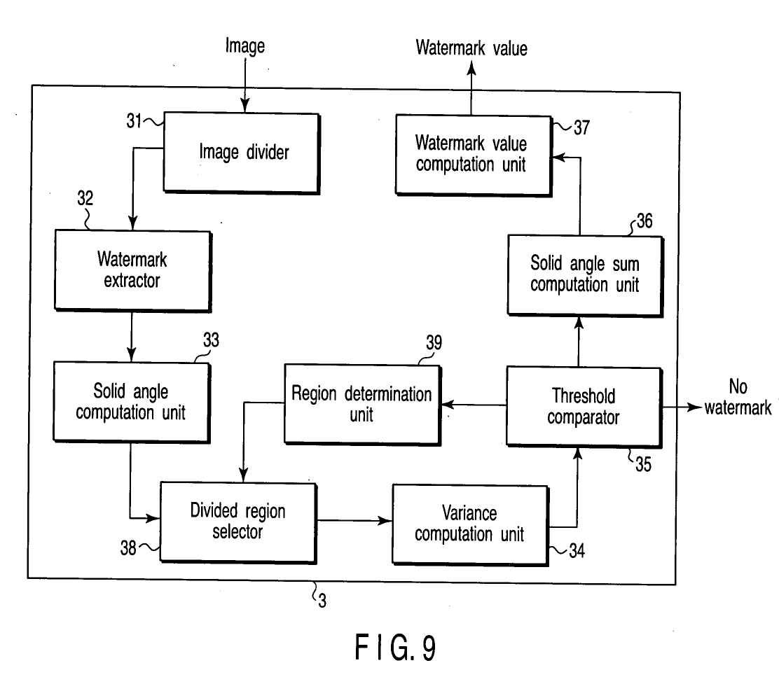

Another configuration example of the digital watermark detector 3 related to the present embodiment is described hereinafter. FIG. 9 shows a configuration example of the digital watermark detector 3 related to the present embodiment.

As shown in FIG. 9, this digital watermark detector 3 is configured by adding a divided region selector 38 and a region determination unit 39 to the configuration example of FIG. 6. In the configuration example of FIG. 6, the small region blocks used for computation of variance are fixed. In contrast, in this configuration example, at first only some of the small region blocks are determined for computation of variance. With the object contents unable of discriminating by simple determination, the determination is done again as increasing the number of small region blocks as object of variance computation sequentially.

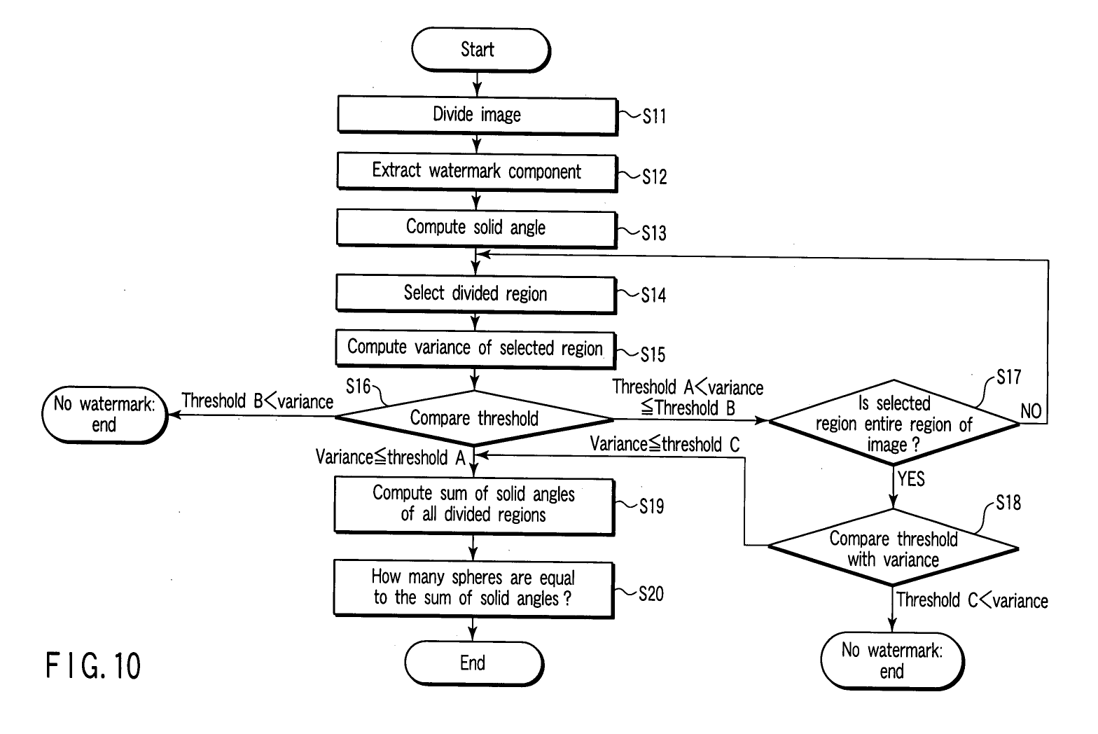

FIG. 10 shows a process procedure of the digital watermark detector 3 of this configuration. The image divider 31 divides an image as object digital contents into a plurality of small region blocks (step S11). The watermark extractor 32 intends for all of small region blocks derived from the object image, and extracts a watermark component from each small region block (step S12). The solid angle computation unit 33 computes a solid angle based on the watermark component for each small region block (step S13).

The divided region selector 38 selects a plurality of small region blocks to be subjected to computation of variance (step S14). There are various kinds of selection methods, for example, a method of selecting at random the predetermined number of small region blocks among all small region blocks derived from an object contents image or a predetermined ratio (the number of selected small region blocks/all small region blocks) or the random number of small region blocks, and a method of selecting the small region blocks in units of one small region block for each of small region blocks satisfying a constant condition of the object contents image (for each group of small region blocks having a constant area or a group of small region blocks having a constant number of pixels)

There are various methods such as a method of selecting one small region block out of one region satisfying a constant condition, a method of selecting one small region block out of a plurality of small region blocks included in the region at random, and a method of selecting a small region block in a predetermined position relation (the center of the region) of a plurality of small region blocks included in the region.

The divided region selector 38 increases the number of small region blocks to be selected whenever the process returns to step S14 from step S17. For the purpose of increasing the number of small region blocks every return from step S17 to step 14, there are various methods such as a method of increasing the small region blocks by the same number, and a method of changing the number of small region blocks to be increased (for example, increasing the number of small region blocks every return from step S17 to step 14).

As for a relation between the initial selected number of small region blocks and the number of small region blocks increased every return from step S17 to step S14, there are a method of making the former and the latter the same, and a method of making the former and the latter differ from each other (making the number of region blocks to be increased when the process returns from step S17 to step 14 to be smaller than the initial number of region blocks.

The variance computation unit 34 computes variance of the solid angles of the selected small region blocks (step S15). There are various algorithms for the variance of the solid angles to be computed. However, any algorithm may be used.

In this configuration example, since the number of sampled solid angles increases every repetition of step S15, it is effective to use the algorithm that can use the data used in step S15. In an algorithm to compute with, for example, the variance of solid angles V=(Σsi)²/T−Σ(si/T)² (si is an angle of the i-th sample, T is the number of samples), if Σsi², Σ(si)² is held, the previous value can be used.

The threshold comparator 35 determines whether or not a watermark is contained in the contents by comparison of the variance with a threshold. In this configuration example, three thresholds A, B and C having relation of A<C<B are used. The threshold C is a standard threshold C. The threshold A makes it possible to determine enough that a digital watermark is included in the contents. The threshold B makes it possible to determine enough that a digital watermark is not included in the contents are prepared. The threshold may be set by a user appropriately, but it is fixed during processing.

At first the threshold comparator 35 compares a variance derived from the object small region block with the threshold A. If variance≦threshold A, it is determined that the possibility that a digital watermark is embedded in the contents is extremely high, and the process advances to step S19 to obtain a watermark value. If threshold B<variance, it is determined that the possibility that a digital watermark is not embedded in the contents is extremely high, and information indicating it is output. If threshold A<variance≦threshold B, the process advances to step S17 to increase objects for variance computation, and to repeat the process (step S16).

In step S17, the region determination unit 39 determines whether the small region blocks selected for variance computation extends over the whole area of the object contents image. If the small region blocks extend over the whole area of object contents image, the object to be subjected to variance computation cannot be increased. Therefore, the process advances to step S18 to compare the variance with the threshold C. If the small region blocks do not extend over the whole area of object contents, the process returns to step S14 to increase an object for variance computation.

In step S18, the variance is compared with the normal threshold C by the threshold comparator 35. If variance≦threshold C, it is determined that a digital watermark is embedded in the contents, and the process advances to step S19 to acquire a watermark value. If threshold C<variance, it is determined that a digital watermark is not embedded in the contents, and information indicating the effect is output.

When it is determined in step S16 that the possibility that a digital watermark is embedded in the contents is extremely high or when it is determined in step S18 that a digital watermark is embedded in the contents, the solid angle sum computation unit 36 computes a sum of solid angles of all small region blocks derived from an object image in step S19.

The watermark value computation unit 37 outputs, as a watermark value (i.e., a value of a topological invariant), the integer value provided by rounding off the sum of solid angles.

According to this configuration example, the probability that the digital watermark system using the topological invariant misdetermines that a digital watermark is contained in the contents though the digital watermark is not embedded therein and outputs a watermark value accidentally can be lowered, and a time required for computing variance without raising probability of a false determination can be shortened.

This is effective particularly when many contents containing no digital watermark are input. Assuming that this configuration example does not use 0 as a watermark value as explained in conjunction with FIG. 8. In this case, when the digital watermark detector detects 0 as a watermark value in the value computation unit 37, a ratio of false detection may be decreased more considering that a digital watermark is not included in the contents.

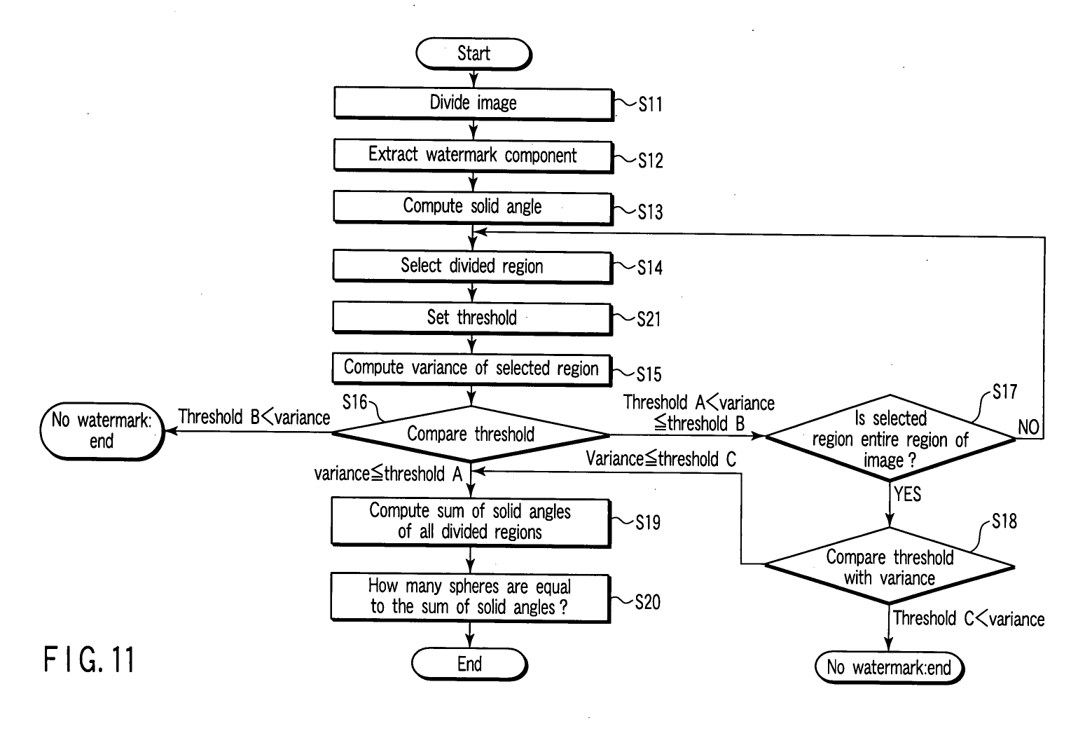

In a procedure example of FIG. 10, the threshold is set at a fixed value. However, in a procedure example of FIG. 11, a process of setting the threshold is added to the procedure example of FIG. 10 (step S21). In this case, the thresholds A and B get closer to the normal threshold C as the number of object small region blocks subjected to variance computation increases by repeat of step S20. Therefore, a threshold adjustment unit (not shown) may adjust the threshold to increase the threshold A gradually and decrease the threshold B gradually whenever step S21 repeats.

In examples of FIGS. 10 and 11, the watermark extractor 32 and the solid angle computation unit 33 perform extraction of a watermark component and computation of a solid angle to all of small region blocks derived from an object image, respectively. In FIG. 10 or 11, a step of selecting a plurality of small region blocks to be subjected to variance computation with the divided region selector 38 in step S14 is moved before a step of computing the solid angle with the solid angle computation unit 33 in step S13. In step S13, the solid angle computation unit 33 may compute a solid angle only on the object small region blocks. Step S14 is moved before step S12 of extracting a watermark component with the watermark extractor 32. In steps S12 and S13, the watermark extractor 32 and body corner computation unit 33 perform extraction of a watermark component and computation of a solid angle on object small region blocks, respectively,

In the examples of FIGS. 9 to 11, a watermark value derived from object contents (i.e., a value of topological invariant) is output as it is. However, the watermark value may be converted into watermark information corresponding to the watermark value and output this watermark information (or a watermark value and watermark information).

There will be explained setting of the threshold to compare with a variance of the solid angles derived from object contents hereinafter. FIG. 12 shows a relation between “variance” derived from watermarked contents obtained when a lot of image samples of various kinds are extracted and “frequency” of the samples from which the variance is derived, and a “variance” derived from the non-watermarked contents and “frequency” of the samples from which the variance is derived. Then, the ratio of False positive is expressed by an area of a part surrounded by a variance axis (a horizontal axis), a solid line of a no-watermark (non-watermarked contents) and a threshold, that is, a part of a hem on the left side of a no-watermark frequency distribution.

As is clear from FIG. 12, when the threshold is set at a low value, a ratio of False positive decreases, and when it is set at a high value, a ratio of False positive increases. There is False negative to determine that a digital watermark is not contained in the contents though the digital watermark is included in the contents.

The ratio of False positive is expressed by an area of a part surrounded by a variance axis (a horizontal axis), a dashed line of a watermark (watermarked contents) and a threshold, that is, a part of a hem on the right side of a watermark frequency distribution.

As understood from comparison of a case of the threshold B with a case of the threshold A in FIG. 12, when the threshold is set at a low value (like A) to lower the ratio of False positive, the ratio of False negative increases. When the threshold is set at a high value to lower the ratio of False positive, the ratio of False positive increases. Generally, False positive and False negative have a relation of trade off to each other, so that it is difficult to bring False positive and False negative close to 0 by a single method.

If it needs not to detect strictly that a digital watermark is included in the contents, but wants to be determined that a digital watermark is not included in the contents, it is desirable to set the threshold at a low value. On the contrary, it is desirable to set the threshold value relatively high in order to detect an image including a digital watermark thoroughly as thus described, it is preferable to use the threshold according to a purpose of a used system or a utilization purpose of a digital watermark. For example, a case to apply the Topological-Invariant watermark to the following anticopy system is considered.

When an image file in which a digital watermark of Copy never is embedded is detected, the detector sends the information of Copy never to a control device to inhibit copying. In the case of an image in which a signal of Copy free is embedded or an image in which a watermark is not embedded, the detector sends the information of Copy free to the control device. The control device performs copying according to operation of the user.

In such a system, in a scene that it is expected that an image based on a personal hobby such as a home video system tends to be applied to a control device, the threshold of the detector in this control device is set at a low value to improve convenience of a user. On the contrary, in the case that pirated edition contents are sold, and a security crackdown must be done, the threshold must be set a high value.

Further, it is possible to adjust the threshold according to the feature of the image. Regardless of whether or not a digital watermark is embedded in the contents, the threshold is set at a high value with respect to the image having large variance, and at a low value with respect to the image having small variance. In this way, it is possible to improve determination accuracy by changing the threshold adaptively.

The threshold may be adjusted manually by a user or automatically by a system. In the former, the user adjusts the threshold in appropriate timing in consideration with a property of the object contents. In the latter, a feature of the contents is obtained by acquiring the feature of the contents or analyzing the contents, based on the information making it possible to identify a feature of the object contents and embedded in the contents, and then a threshold corresponding to the feature is derived from transformation functions or a transformation table.

As thus described, the present embodiment does not use a single threshold but may change a threshold according to a system or a feature of an image. It becomes possible to do determination according to request of high precision. Further, it is possible to do determination of higher precision by combining a determination system of the present embodiment and other determination systems. For example, if determination of False positive is done by a determination system of the present embodiment strictly and a determination of False negative is done by other systems strictly, the detection precision can be improved.

In the present embodiment will be described a case that all of a plurality of small region blocks obtained by dividing an image of object contents are used for embedment of a digital watermark. A method of embedding a watermark in only a part of region of an image (for example, a method of embedding a watermark in only a central portion of the image without embedding a watermark in the peripheral portion of the image) may be employed. In the case of this method, a region used for embedding a digital watermark among the region of the image may be assumed to be an object to be processed.

In the present embodiment is explained an example in which (still) image data is intended for as an example of digital contents. However, another media data can be used. In the present embodiment is explained the Topological-Invariant watermark system using tolopogical invariant. However, the present embodiment can implement with another digital watermark system which acquires a watermark value based on a digital watermark component derived from contents or a value obtained from the digital watermark component, and in which variance of all or some of the watermark components derived from the contents or values obtained based on them differs between the watermarked contents and the non-watermarked contents.

Each function described above is realizable by a computer having suitable mechanism described as software. The present embodiment can implement as program for causing a computer to execute a predetermined procedure, causing a computer to function as a predetermined measure, or causing a computer to execute a predetermined function. The embodiment can provide as a computer readable medium storing the program.

An appropriate combination of a plurality of components disclosed by the embodiment can form various kinds of invention. According to the present invention, probability of False positive can be lowered in a digital watermark system with the use of topological invariant.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A digital watermark detecting apparatus to detect a digital watermark contained in digital contents, comprising:
a contents divider to divide digital contents into a plurality of divided regions;
an acquisition unit configured to acquire a plurality of base values for computation of a digital watermark value, which are contained in all or some of the plurality of divided regions, respectively;
a computation unit configured to compute variance of the base values; and
a watermark determination unit configured to determine whether the digital watermark value is contained in the digital contents, based on comparison of the computed variance with a threshold.

2. The digital watermark detecting apparatus according to claim 1, which further comprises a computation unit configured to compute the digital watermark value based on the base values acquired on all of the divided regions required for computation of the digital watermark value, when the determination unit determines that the digital contents includes the digital watermark value.

3. The digital watermark detecting apparatus according to claim 2, which further comprises an output unit configured to output the computed digital watermark value or a value obtained by converting the computed digital watermark value.

4. The digital watermark detecting apparatus according to claim 3, wherein the output unit is configured to output information representing that the digital contents fails to contain the watermark value, when a specific value is given as the digital watermark value.

5. The digital watermark detecting apparatus according to claim 4, wherein the specific value is 0.

6. The digital watermark detecting apparatus according to claim 1, which further comprises an output unit configured to output information representing that the digital contents fails to contain the digital watermark value, when the determination unit determines that the digital watermark value fails to be include in the digital contents.

7. The digital watermark detecting apparatus according to claim 1, wherein the determination unit is configured to determine that the digital contents contain the digital watermark value when the variance is not more than the threshold and to determine that the digital contents fail to contain the digital watermark when the variance exceeds the threshold.

8. The digital watermark detecting apparatus according to claim 7, wherein the divided regions provided for computation of the variance include all of the divided regions required for computation of the watermark value or some of the divided regions selected therefrom by a predetermined technique.

9. The digital watermark detecting apparatus according to claim 1, which further comprises a selector to select the divided regions to be provided for computation of the variance from all of the divided regions that are necessary for computation of the watermark value, and an unselected determination unit configured to determine whether there is an unselected divided region, the watermark determination unit is configured to use as the threshold a first threshold, a second threshold smaller than the first threshold and a third threshold larger than the first threshold, determines that the digital contents contain the watermark value when the variance is not more than the second threshold, and determines that the digital contents fail to contain the digital watermark value, when the variance exceeds the third threshold, and wherein the selector selects the number of divided regions larger than that selected in a previous time when the divided regions fail to be selected yet or when the watermark determination unit determines that the variance exceeds the second threshold and is not more than the third threshold, and determines that unselected divided regions exist.

10. The digital watermark detecting apparatus according to claim 9, wherein in cases where the watermark determination unit determines that the variance exceeds the second threshold and is not more than the third threshold, and determines that unselected divided regions fail to exist, the watermark determination unit determines that the digital contents contain the digital watermark when the variance is not more than the first threshold, and it determines that the contents fail to contain the digital watermark when the variance exceeds the first threshold.

11. The digital watermark detecting apparatus according to claim 9, wherein the selector selects the divided regions for computation of the variance from all of the divided regions necessary for computation of the watermark value by a random technique.

12. The digital watermark detecting apparatus according to claim 9, wherein the selector selects, from all of the divided regions necessary for computation of the value of the watermark, the divided regions for computation of the variance one by one every small region group satisfying a constant condition.

13. The digital watermark detecting apparatus according to claim 1, which further comprises a setting unit configured to set the threshold according to a utilization purpose of the digital watermark.

14. The digital watermark detecting apparatus according to claim 1, which further comprises a setting unit configured to set the threshold according to a feature of the digital contents.

15. The digital watermark detecting apparatus according to claim 1, wherein the digital watermark value is topological invariant.

16. The digital watermark detecting apparatus according to claim 15 wherein the topological invariant is homotopy invariant.

17. The digital watermark detecting apparatus according to claim 15, wherein the acquisition unit is configured to extract vectors corresponding to components of watermark values which are contained in the divided regions, respectively, and compute solid angles concerning the divided regions from the extracted vectors, the solid angles corresponding to the base values.

18. The digital watermark detecting apparatus according to claim 1, wherein the digital contents include still image data, video data or audio data.

19. A method of detecting a digital watermark contained in digital contents, comprising:
dividing the digital contents into a plurality of divided regions;
acquiring a plurality of base values for computation of a watermark value, which are contained in the divided regions, based on contents of all or some of the divided regions;
computing variance of the base values; and
determining whether the digital contents contain the watermark value based on a comparison result between the variance and a threshold.

20. A program stored in a computer readable medium for detecting a digital watermark contained in digital contents, the program including:
means for instructing a computer to divide the digital contents into a plurality of divided regions;
means for instructing the computer to acquire base values for computation of a watermark value, which are contained in the divided regions, based on contents of all or some of the divided regions;
means for instructing the computer to compute variance of the base values; and
means for instructing the computer to determine whether the digital contents contain the watermark value based on comparison result between the variance and a threshold.
